(19) United States
(12) Patent Application Publication
(10) Pub. No.: US 2024/0224905 A1
(43) Pub. Date: Jul. 11, 2024

(54) SOILLESS PLANT-CULTURE SYSTEM

(71) Applicant: FARM3, VERRIERES-DE-JOUX (FR)

(72) Inventor: Romain SCHMITT, Paris (FR)

(73) Assignee: FARM3, VERRIERES-DE-JOUX (FR)

(21) Appl. No.: 17/800,098

(22) PCT Filed: Feb. 2, 2021
(86) PCT No.: PCT/EP2021/052405

§ 371 Date: Feb. 22, 2023

(30) Foreign Application Priority Data
Feb. 17, 2020 (FR) 2001534

(51) Int. Cl. A01G 31/02

(52) U.S. Cl. CPC A01G 31/02

(57) ABSTRACT

A soilless plant-culture system in which the plants are arranged in a support structure having a plurality of closed spaces, such that the roots of each plant are in one of the closed spaces, the system including: a spray head having at least one spray nozzle that includes a piezoelectric sprayer, a supply element of at least one plant nutrient solution, a displacement element arranged to move the spray head between the closed spaces, and a control element arranged to control the at least one nozzle and to control the displacement element so as to move the spray head between the closed spaces. The spray head is arranged to spray the nutrient solution into each closed space over a predetermined duration and with a predetermined frequency.

### TECHNICAL FIELD

The present invention relates to a soilless plant-culture system.

The field of the invention is, in a non-limiting manner, that of culture of plants. More particularly, but in a non-limiting manner, the field of the invention is that of vertical culture.

### PRIOR ART

Aeroponics is a form of soilless farming or culturing that allows plants to be grown without soil. The plants are supported by support structures so that their roots are in the air. Water and nutrients are supplied by regularly spraying solutions containing minerals. Since the plants use less energy to take up water, they can use more energy to develop their upper parts (stems, leaves, fruit, etc.). This culture technique results in significant water and nutrient savings and produces a high yield.

One method of spraying and thus of obtaining fine drops of solution is to propel the solution using a high-pressure pump through spray nozzles (also referred to as high-pressure aeroponics). However, this method has the following drawbacks:
Nozzles can become clogged, thus requiring regular maintenance. In particular, organic solutions (as opposed to chemical fertiliser-based solutions) cannot be used because they are too viscous and would instantly clog the nozzles. Moreover, if the plants do not receive the required quantity of nutrient solution (for example 3s of spray every 5 minutes), the roots dry out as there is no medium to gain time and the plant dies within the hour.
The dosage of the nutrients is all the more complex because every spray counts.
Each plant has different needs, in particular as regards nutrients.
The aeroponics system uses a pump that wears out as a result of being turned on and off repeatedly. Moreover, it only delivers the required pressure for a certain number of nozzles.

The purpose of the present invention is to provide a culture system that overcomes at least one of these drawbacks.

### DESCRIPTION OF THE INVENTION

This is achieved with a soilless plant-culture system, the plants being arranged in a support structure comprising a plurality of closed spaces, such that the roots of each plant are in one of the closed spaces, the system comprising:
a spray head comprising at least one spray nozzle comprising a piezoelectric sprayer,
supply means of at least one plant nutrient solution,
displacement means arranged to move the spray head between the closed spaces, and
control means arranged to:
   control the at least one nozzle,
   control the displacement means so as to move the spray head between the closed spaces,
the spray head being arranged to spray the nutrient solution into each closed space over a predetermined duration and with a predetermined frequency.

The system according to the present invention allows for the combined use of an ultrasonic sprayer or fogger and a nozzle. The nozzle comprising the sprayer has low energy consumption and thus does not heat up during operation. It can be used for viscous solutions, i.e. complex mixtures such as organic fertilisers.

The spray head with the at least one nozzle is capable of moving along one or more plant support structures. A plurality of support structures forms a culture wall. The same one or more nozzles can thus be used for a plurality of support structures and a large number of plants. The system according to the invention is thus very economical.

The supply means can comprise:
storage means of a plurality of nutrients, and
a source of filtered water.

The nutrient storage means and the water source are hydraulically coupled to the at least one nozzle by a system of pumps.

According to a particularly advantageous embodiment, the storage means can comprise a plurality of tanks, each tank containing a plant nutrient.

The supply means can comprise at least one dosing or mixing tank, arranged to mix at least one of the nutrients with water to obtain a nutrient solution.

The solution obtained in the dosing tank is thus intended for a type of plant present in the support structure. When the spray head moves along the structure towards another type of plant with different needs, another solution adapted to that type of plant must be dosed in the dosing tank.

Preferably, the control means are arranged to dose one or more nutrients as a function of the plants present in the structure.

According to a preferred embodiment, the system according to the invention can further comprise cleaning means configured to clean the at least one nozzle between spraying operations of different nutrient solutions.

Thus, when the same nozzle is required to spray different nutrient solutions, for example by moving along the culture wall, the nozzle is cleaned of any residue from the previous solution before spraying the next solution, to ensure that the next solution is not contaminated by residue from the previous solution.

The cleaning means can comprise a cleaning tank containing a cleaning solution. The spray head can thus spray the cleaning solution into a closed space before and/or after spraying the nutrient solution.

The cleaning solution must be harmless to plants. The cleaning solution can be, for example, a hypochlorous acid solution.

According to an advantageous embodiment, the supply means can comprise measuring means arranged to measure a nutrient content of the solution.

Measurements can be made, for example, by determining the chemical composition of the solution, or the pH value thereof.

Advantageously, the measuring means can be arranged to provide real-time measurements of the nutrient content.

The displacement means preferably comprise horizontal and/or vertical rails along which the spray head can move.

The displacement means can comprise a motor arranged to move the head along the rails. The motor can be positioned on the spray head. The motor can be a stepper motor controlled by a stepper motor driver board.

According to one example, the motor is connected to a cable chain to propel the spray head along the rails.

The control means preferably comprise at least one microcontroller. This in particular allows the displacement of the head and the duration and frequency of spraying operation to be controlled, by enabling and disabling the motor and the spraying operation.

The microcontroller can be arranged on the spray head, for example on the motor.

Advantageously, the microcontroller receives commands via a central processing unit communicating with a cloud. Databases are stored in the cloud and contain plant information and plant-specific spraying instructions (frequency and duration of spraying, type of nutrient solution), etc.

According to a particularly advantageous embodiment, the supply means can form a closed circuit.

For this purpose, the culture system can further comprise means for recycling the at least one nutrient solution.

Thus, the nutrient solution sprayed into the closed spaces containing the roots of the plants (also referred to as root chambers) and that has not been completely taken up by the roots, is collected and/or recycled for reuse during a subsequent spraying operation.

According to a first example, the solution collected can be filtered via a reverse osmosis system, which retains the nutrients, in order to obtain purified water. This purified water can be reused as a source of filtered water and mixed with nutrients to produce a new solution to be sprayed.

According to a second example, the unused solution can be directly collected in a tank, for example in the dosing tank from which the solution was previously drawn, in order to be reused during the next spraying operation. In such a case, the solution can be reused for a determined period of time, for example one week, and then replaced.

The system according to the invention preferably comprises a support structure inside which plants are arranged, the support structure comprising a plurality of closed spaces, such that the roots of each plant are located in one of the closed spaces.

According to a particularly advantageous embodiment, the system can further comprise at least one fan per closed space, the fan being disposed in the closed space so as to be able to ventilate the solution sprayed throughout the closed space.

Thus, when the solution is sprayed into a closed space (or root chamber), the at least one fan is enabled so as to ensure that the mist produced by the spray correctly envelops the roots of all plants growing in this chamber in a uniform manner.

### DESCRIPTION OF THE FIGURES AND EMBODIMENTS

Other advantages and features will become apparent upon examining the detailed description of non-limiting examples, and from the accompanying drawings in which:

FIG. 1 is a partial, diagrammatic view of a spray head of the culture system according to one embodiment of the invention,

FIG. 2 is a partial, diagrammatic view of the system according to one embodiment of the invention,

FIG. 3 shows perspective views of a plant support structure of the system according to one embodiment,

FIG. 4 shows diagrammatic views of plant pots for the support structure of the system,

FIG. 5 is a diagrammatic view of a spray head with displacement means according to one embodiment of the system, and

FIG. 6 is a hydraulic circuit diagram of the system according to one embodiment of the invention.

It is understood that the embodiments described hereinbelow are by no means limiting. In particular, alternative embodiments of the invention can be conceived, comprising only a selection of the features described hereinbelow separately from the other features described, if this selection of features is sufficient to confer a technical advantage or to differentiate the invention from the prior art. This selection comprises at least one preferably functional feature without structural details, or with only part of the structural details if this part alone is sufficient confer a technical advantage or to differentiate the invention from the prior art.

In particular, all the embodiments and alternative embodiments described can be combined with one another, provided that such a combination is technically possible.

Identical elements in the figures keep the same reference numerals.

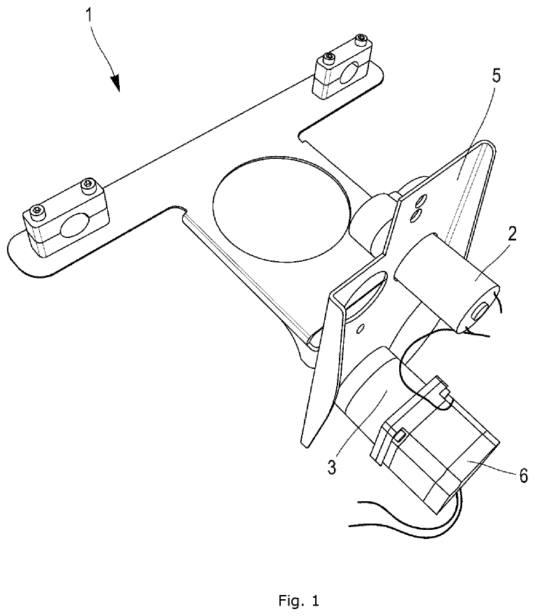

A culture system according to embodiments of the invention will be described hereinbelow with reference to FIG. 1 to 5.

FIG. 1 is a diagrammatic view of a non-limiting example embodiment of a spray head of a culture system according to the invention.

The spray head 1, shown in part in FIG. 1, comprises a support 5 on which at least one spray nozzle 2 is disposed. The spray head 1 allows a nutrient solution to be sprayed onto plants, in particular onto the roots thereof. In the example shown in FIG. 5, two nozzles 2 are present. The two nozzles 2 can be used simultaneously during a spraying operation, or alternately. The second nozzle further allows the head to continue to operate in the event that the first nozzle 2 fails.

The spray head 1 further comprises a pump 6 for each nozzle 2 in order to deliver nutrient solution to these nozzles 2. This pump 6 is preferably a peristaltic pump.

The ultrasonic spraying operation is carried out by delivering a solution to be sprayed through the nozzle 2 via the pump 6. The nozzle 2 comprises a piezoelectric element or motor, and a ceramic membrane. The piezoelectric motor is arranged to vibrate the membrane at a frequency that disperses the solution exiting the nozzle into droplets of a size that is adapted for uptake by plant roots. An optimal size for root uptake is about 40 μm.

The nozzle 2 shown in FIG. 1 is a nozzle by the company Tekceleo.

The system according to the invention comprises a motor 3 arranged on the spray head 1. This motor 3 is used to move the head when spraying nutrient solution, as will be described in more detail hereinbelow. The motor 3 can, for example, be a stepper motor.

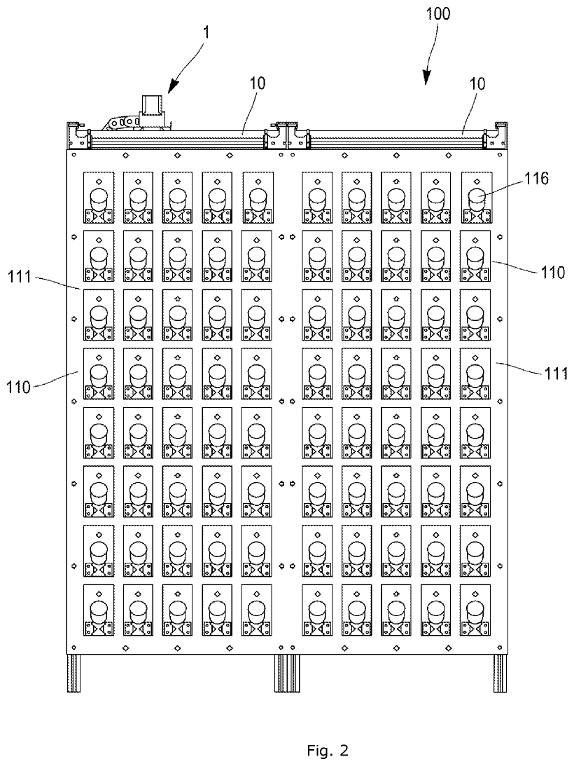

FIG. 2 diagrammatically shows an embodiment of a plant-culture system according to the present invention.

The system 100, according to the example shown in FIG. 2, comprises two plant support structures 110. All support structures 110 are considered to comprise the same features as the structure 110 described hereinbelow and the description of the system 100 according to the invention will remain valid when replacing the support structure 110 with “the at least one support structure” or “each support structure”. A support structure 110 may also be referred to as a “shelf” hereinbelow.

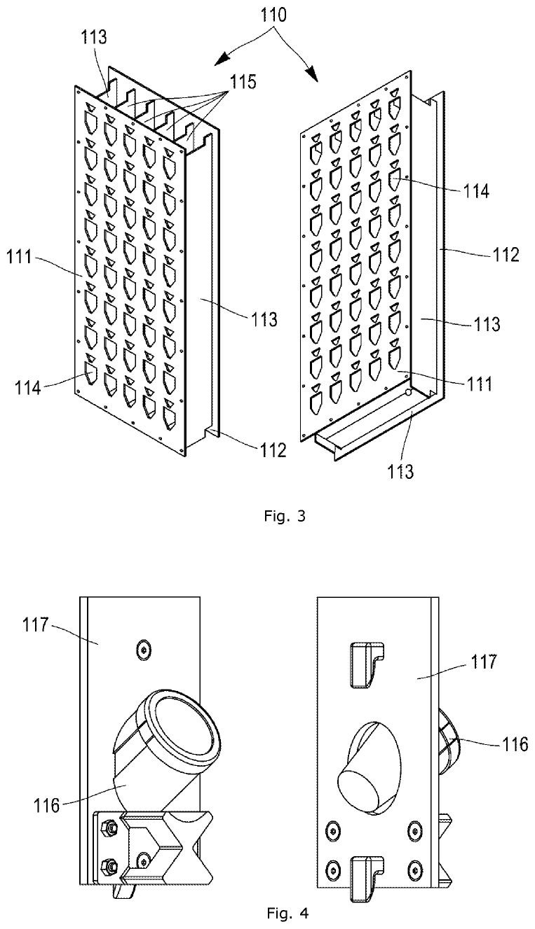

The support structure 110 consists of a hollow wall, as shown in FIG. 3, from two different perspectives. The hollow wall is formed by a front panel 111, a back panel 112 and four side panels 113 (the top one whereof is not shown). Inner panels 115 divide the wall into a plurality of columns forming closed spaces, also referred to as root chambers.

The front panel 111 has a plurality of apertures 114 which constitute locations for the plants. Each location 114 can receive a pot 113, for example a pierced pot, which is intended to accommodate a plant such that the roots of the plant are located inside the structure 110 in a root chamber.

Root chambers are closed spaces, which means that they are impervious to light and potentially to air. This prevents contamination of the roots by pathogens such as bacteria or viruses, and by micro-algae. Micro-algae stimulate the development of plant diseases, can soil the culture system and coat the roots, thus preventing them from receiving the nutrient solution. Even if the root chamber is not completely airtight, the darkness prevents micro-algae from developing in this humid environment.

According to one example, in the case of a spraying operation from the top of the hollow wall 110, the panel closing the top of the hollow wall 110 can be provided with a flap for each root chamber. This flap opens when the spray head 1 passes over it to let the solution mist pass therethrough and closes after spraying.

The system 100 according to the invention can include one or more of these support structures 110, to form a supporting or culture wall.

A vertical culture wall is typically 3 metres high.

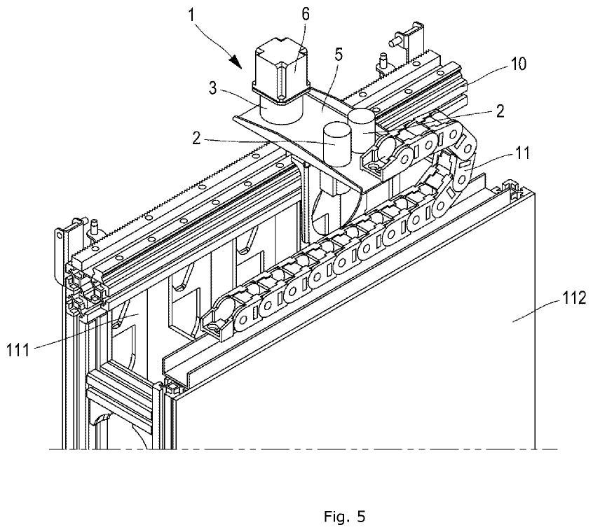

FIG. 4 shows an example of a pierced pot 116, on both sides, in its support 117 to be inserted into an aperture 114 in the support structure 110. Other pot shapes are of course possible, depending on the growth characteristics of the plant (upwards, plant size, etc.).

The system 100 according to the invention comprises displacement means arranged to move the spray head 1 between the closed spaces of the support structure 110.

FIG. 5 shows one embodiment of the displacement means comprising horizontal rails 10. The horizontal rail 10 shown in FIG. 5 is disposed at the top of a wall 111 of a plant support structure 110. The spray head 1 can be propelled along this rail 10 by the motor 3 thereof. Propulsion can be achieved, for example, by means of a gear system between the motor 3 and the rail 10.

As shown in FIG. 5, a cable chain 11 connected to the spray head is provided to contain and protect cables for the power supply to the nozzles 2, the motor 3 and the pumps 6 as well as the hydraulic cables for delivering solutions to the nozzles 2.

According to advantageous embodiments, one same rail 10 can run along a supporting wall formed by a plurality of support structures 110. A single spray head 1 can thus be used to move along the rail 10 to spray a solution onto the plants present in this supporting wall.

The displacement means further comprise the motor arranged on the spray head 1. The motor 3 allows the head 1 to move on the rails 10.

Alternatively or in addition thereto, the displacement means can further comprise vertical rails. In such a case, one vertical rail must be provided for each root chamber.

The spray head 1, because of its mobility, can also be referred to as a “robotic fogger”.

The culture system according to the present invention comprises supply means for supplying nutrient solutions to the plants in the structures 110. These supply means comprise all of the tanks, pumps, pipes, etc., required to store and dose nutrients and to store, deliver and discharge nutrient solutions.

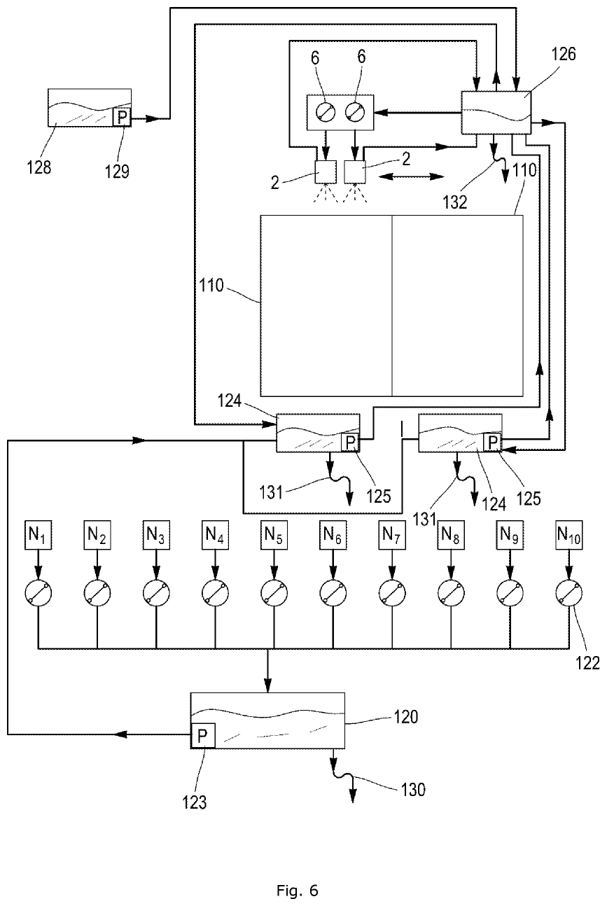

FIG. 6 shows one example embodiment of a hydraulic circuit diagram for the system 100 according to the invention. There are two plant support structures 110 in the example shown, forming a supporting wall. The supply means comprise:
pure nutrient storage bottles Nₓ (X=1 . . . 10 in the example shown),
a dosing or mixing tank 120 in which one or more nutrients can be mixed with water, preferably filtered water, to form a nutrient solution,
one storage tank 124 for each structure 110 (thus two storage tanks 124 in the example shown) to store the nutrient solution adapted to the plants present in each structure 110, in sufficient quantity for a certain period of time (for example a few days or a week),
a so-called intermediate tank 126 for storing the nutrient solution required for one spraying session for a shelf 110,
a peristaltic pump 122 for each bottle of nutrient Nₓ to pump the relevant nutrient into the dosing tank 120,
a cleaning tank 128 for storing a cleaning solution to clean the nozzle 2 or nozzles 2,
water pumps 123, 125, 129 for pumping the solution from the dosing tank 120 into the storage tank 124, from the storage tank 124 into the intermediate tank 126, and from the cleaning tank 128 into the intermediate tank 126, respectively, and
potentially a pump 6 for each nozzle 2.

A source of filtered water is not shown in the drawing in FIG. 6. The water inlet can, for example, be coupled to a reverse osmosis membrane to filter the water, before it is fed into the dosing tank 120. The source of filtered water can also be constituted by water that has been collected, recycled and filtered.

The system 100 further comprises discharge means. All of the tanks 120, 124, 126, 128 can in particular be connected to the sewer 130, 131, 132.

Nutrients can comprise: phosphorus, nitrogen, potassium, calcium, sulphur, magnesium, micronutrients, organic fertiliser, and pH stabilisers (pH UP, pH Down), etc. The mixture of a plurality of these nutrients allows them to be dosed precisely in a way that is perfectly adapted to the needs of each plant, while controlling the pH. Thus, any type of plant can be grown in the same culture system.

Nutrients can also take the form of solutions, referred to as initial solutions. Other initial solutions different to those mentioned can of course be used.

The nutrient solution is obtained in the dosing/mixing tank 120. Nutrient solutions Nₓ can be dosed automatically, as described in more detail hereinbelow.

The solutions mixed in the dosing tank 120 are stored in the storage tanks 124 beneath the shelves. Each shelf 110 is associated with its own storage tank 124, containing the nutrient solution adapted to the plants in the shelf. The solution is delivered by a water pump 125, associated with each storage tank 124 and controlled by a microcontroller, to the intermediate tank 126.

The intermediate tank 126 can be located inside or outside the nozzle 2. In the case of a tank outside the nozzle, during spraying, the pump 6 is enabled and supplies the solution to be sprayed from the intermediate tank 126 to the nozzle 2. When the tank is inside the nozzle 2, the latter does not require a pump for spraying.

The intermediate tank 126 allows for the regulation of the nozzle containing the nutrient solution to be sprayed and collecting the excess, unsprayed solution. Preferably, the intermediate tank 126 contains only the quantity of nutrient solution required for one spraying session.

A first nutrient solution is used to sprinkle, by spraying, the plants of a first shelf 110. Solution is sprayed into each root chamber of the shelf. Thus, as the robotic fogger 1 moves along the wall and arrives above another shelf 110, a different nutrient solution may be required, depending on the plants present in this other shelf.

The same nozzle 2 is used to sprinkle a certain number of plants with one and the same solution, and then moves to sprinkle different plants with a different solution. It goes without saying that when the plants in the shelves making up a wall are the same, the solutions stored for each shelf are also the same.

The watering solution of a shelf that has not been taken up by the roots falls by gravity into the root chambers and flows into the storage tank.

The supply means can form a closed circuit. This means that:
the sprayed solutions not taken up by the roots are collected in the storage tanks 124 for each shelf 110 for reuse or recycling, and/or
the nutrient solution mixed in the dosing tank 120 can be recycled at any time and replaced according to the needs of the plants,

The solutions are recycled by filtration through a reverse osmosis filtration system and reuse of the filtered water. The membranes in which the nutrients are trapped are replaced regularly, for example once a year.

When different plants, requiring different nutrient solutions, are present in each structure 110 forming the wall and only one spray head is used for this wall, the different nutrient solutions must be sprayed with the same spray head, in particular with the same nozzle.

In this case in particular, once the nutrient solution for a support structure 110 has been sprayed, the spray head moves to the next structure and a cleaning solution is sprayed. This cleaning solution is used to clean the one or more nozzles. It is harmless to plants. The cleaning solution can be, for example, a hypochlorous acid solution.

The nozzles can be cleaned generally before and after each spraying operation, and in particular when plants in the shelves have been changed.

The system according to the present invention further comprises control means. The control means allow the one or more nozzles 2 to be controlled, as well as the motor 3 for moving the spray head 1 and the various water and peristaltic pumps of the system 100.

The control means comprise a control station (not shown). This can be remote from the plant support structure. This control station comprises at least one computer, a central processing or computing unit, an analogic electronic circuit (preferably a dedicated circuit), a digital electronic circuit (preferably a dedicated circuit), and/or a microprocessor (preferably a dedicated microprocessor), and/or software means. The control station can be arranged so that an operator can control the spray head, dosing, etc. manually.

The control station can communicate with a cloud where data concerning the sprinkling of the plants is stored. A database contains the frequency and duration of spraying operation for each plant or type of plant as well as the data needed for the composition of the nutrient solution adapted for each plant or type of plant. The control station can furthermore communicate, for example via Bluetooth, with microcontrollers in order to transmit commands received from the cloud.

A computing unit, performing the operations of the control station, can be disposed on an element of the culture system, for example on a robotic arm handling the plants in the shelves, or in one of the shelves.

The control means further comprise microcontrollers (not shown).

The pumps 122 associated with the nutrient tanks Nₓ are controlled by microcontrollers receiving commands from the cloud via the central computing unit, allowing the dosage of the different nutrients to be controlled (i.e. as a function of the plants present in the structure). The pumps 122 are preferably peristaltic pumps, with a stepper motor. The microcontrollers can be, for example, ESP32 microcontrollers. These microcontrollers feature Bluetooth/Wi-Fi connectivity and are very economical. The microcontrollers can be connected to the pumps by a wired connection, with each pump having its own microcontroller.

The motor of each pump 122 can be equipped with a driver board (for example of the type A4988) for receiving and executing commands received from the microcontroller. Each microcontroller sends a command to the driver board of the corresponding pump 122. This command is of the “On/Off” type, corresponding to the starting and stopping of the pump 122 respectively. The duration of “On” defines the quantity of solution drawn from the relevant nutrient tank Nₓ.

The motor 3 associated with the spray nozzle 2 is also provided with a microcontroller to enable and disable spraying operation and to enable and disable the motor 3. The microcontroller is preferably attached to the motor 3 on the spray head 1. For example, this can be an ESP32 microcontroller. The motor 3 can be equipped with a driver board (for example of the type A4988) for receiving and executing commands received from the microcontroller.

If the control station and the cloud become disconnected or the control station and a microcontroller become disconnected, the microcontrollers can continue to operate according to the last command received.

An operator can also intervene on the cloud from the control station to make adjustments, for example to adjust the flow rate of the pumps per nutrient, or the spraying time for a certain support structure, etc.

According to one embodiment of the system according to the invention, the dosing tank 120 and/or the storage tanks 124 can be equipped with measuring means, arranged to measure the composition, or the nutrient content, of the nutrient solution present in these tanks.

According to one example, the measurements can be made by monitoring the flow rate of the different pumps.

According to another example, the dosing tank 120 and/or the storage tanks 124 can be equipped with pH sensors to monitor the pH value of the nutrient solutions.

According to one embodiment of the system according to the invention, at least one fan can be provided in the support structure 110. The fan is located inside a root chamber. When a nutrient solution is sprayed, operation of the fan allows the sprayed solution to be ventilated throughout the root chamber. This ensures that the roots of all plants present are sprinkled evenly and homogeneously, even if roots of one plant are in the path of the solution's droplets between the spray head and the roots of another plant.

According to one example, the fan can be inserted into one of the apertures provided for the plants, such that it is located inside a root chamber. The fan can be powered by a battery.

It goes without saying that the invention is not limited to the examples described hereinabove, and numerous adjustments can be made to these examples while still remaining within the scope of the invention.

1.-15. (canceled)

16. A soilless plant-culture system, the plants being arranged in a support structure comprising a plurality of closed spaces, such that the roots of each plant are in one of the closed spaces, the system comprising:
a spray head comprising at least one spray nozzle comprising a piezoelectric sprayer, supply means of at least one plant nutrient solution,
displacement means arranged to move the spray head between the closed spaces, and control means arranged to:
control the at least one nozzle,
control the displacement means so as to move the spray head between the closed spaces,
the spray head being arranged to spray the nutrient solution into each closed space over a predetermined duration and with a predetermined frequency.

17. The system according to claim 16, wherein the supply means comprise:
storage means of a plurality of nutrients, and
a source of filtered water,
the nutrient storage means and the water source being hydraulically coupled to the at least one nozzle by a system of pumps.

18. The system according to claim 17, wherein the storage means comprise a plurality of tanks, each tank containing a plant nutrient.

19. The system according to claim 16, wherein the supply means comprise at least one dosing tank, arranged to mix at least one of the nutrients with water to obtain a nutrient solution.

20. The system according to claim 19, wherein the control means are arranged to dose one or more nutrients as a function of the plants present in the structure.

21. The system according to claim 16, further comprising cleaning means configured to clean the at least one nozzle between spraying operations of different nutrient solutions.

22. The system according to claim 21, wherein the cleaning means comprise a cleaning tank containing a cleaning solution, the spray head being arranged to spray the cleaning solution into a closed space before and/or after spraying the nutrient solution.

23. The system according to claim 16, wherein the supply means comprise measuring means arranged to measure a nutrient content of the solution.

24. The system according to claim 16, wherein the displacement means comprise horizontal and/or vertical rails along which the spray head is arranged so as to move.

25. The system according to claim 24, wherein the displacement means comprise a motor arranged on the spray head and arranged to move the head on the rails.

26. The system according to claim 16, wherein the control means comprise at least one microcontroller arranged to control the displacement of the head and the duration and frequency of spraying operation.

27. The system according to claim 16, wherein the supply means form a closed circuit.

28. The system according to claim 16, further comprising means for recycling the at least one nutrient solution.

29. The system according to claim 16, further comprising a support structure inside which plants are arranged, the support structure comprising a plurality of closed spaces, such that the roots of each plant are located in one of the closed spaces.

30. The system according to claim 16, further comprising at least one fan per closed space, the fan being disposed in the closed space so as to be able to ventilate the solution sprayed throughout the closed space.
